(19) United States
(12) Patent Application Publication
(10) Pub. No.: US 2002/0011914 A1
(43) Pub. Date: Jan. 31, 2002

(54) Transformer

(76) Inventors: Takeyoshi Ikeura, Kyoto-shi (JP); Keisuke Fujii, Nagaokakyo-shi (JP); Hiroyuki Kawamoto, Chiang Mai (TH); Yasunori Ijiri, Kyoto-shi (JP)

Correspondence Address: OSTROLENK FABER GERB & SOFFEN, 1180 AVENUE OF THE AMERICAS, NEW YORK, NY, 100368403

(21) Appl. No.: 09/863,078

(22) Filed: May 22, 2001

(30) Foreign Application Priority Data
May 22, 2000 (JP) 2000-150429

(51) Int. Cl. H01F 27/30

(52) U.S. Cl. 336/208

(57) ABSTRACT

A transformer includes a bobbin. The bobbin includes a first cylindrical member, and a second cylindrical member having a larger diameter than the first cylindrical member. The first cylindrical member and the second cylindrical member are integrally formed in a concentric arrangement with a gap therebetween. A first winding, implemented by an air-core coil, is inserted into the gap between the first and second cylindrical members of the bobbin, and serves as an input winding which allows a large current in association with a low voltage to flow therethrough. A second winding is wound on the second cylindrical member of the bobbin, and serves as an output winding which allows a small current in association with a high voltage to flow therethrough.

### BACKGROUND OF THE INVENTION

1. Field of the Invention

The present invention generally relates to transformers, and more particularly to a transformer for use in a high voltage power supply.

2. Description of the Related Art

FIG. 4 is a perspective view of a conventional transformer. Transformer 1 includes a bobbin 2 having a primary winding 3 and a secondary winding 4 wound thereon. The bobbin 2 includes a cylindrical member having a plurality of flanges extending radially from the cylindrical member. A relatively thick wire is used for the primary winding 3 so as to allow a large current in association with a low voltage to flow therethrough. The ends of the primary winding 3 are connected to the terminals 5 provided on the bobbin 2. A relatively thin wire is used for the secondary winding 4 so as to allow a small current in association with a high voltage to flow therethrough. The ends of the secondary winding 4 are not connected to the terminals 5. The primary winding has a greater number of turns than the secondary winding. If needed, a tertiary winding (not shown) is wound on the bobbin at a location adjacent to the primary winding 3. The ends of the tertiary winding are connected to the terminals 5. A thin wire is typically used for the tertiary winding because a large current does not flow therethrough.

FIG. 5 is an exploded perspective view of another conventional transformer 10. Transformer 10 includes a pair of bobbins 11 and 14. A primary winding 12 is wound on the first bobbin 11 and a secondary winding 15 is formed on the second bobbin 14. A central aperture (not numbered) of the second bobbin 14 receives the primary winding 12 wound on the first bobbin 11. A relatively thick wire is used for the primary winding 12 so as to allow a large current in association with a low voltage to flow therethrough. The ends of the primary winding 12 are connected to terminals 13 provided on the first bobbin 11. A relatively thin wire is used for the secondary winding 15 so as to allow a small current in association with a high voltage to flow therethrough. The ends of the secondary winding are not connected to the terminals 13. The primary winding has a smaller number of turns than the secondary winding. If needed, a tertiary winding (not shown) is wound on the first bobbin 11 adjacent the primary winding 12. The ends of the tertiary winding are also connected to terminals 13. A thin wire is typically used for the tertiary winding because a large current does not flow therethrough.

In the transformer 1 shown in FIG. 4, the component costs are relatively small because all the windings are wound on the single bobbin 2. However, the degree of coupling between the windings is low. In addition, because the process used to wind two or more wires having different thicknesses on the single bobbin 2 is time consuming, particularly for changing the wires, the cost of manufacture is increased. Furthermore, because a core (not shown) is provided through a central aperture of the bobbin 2, and its potential is substantially equal to ground, measures must be taken to provide insulation between the core and the secondary winding 4 to which a high voltage will be applied. While this problem can be addressed by increasing the thickness of the bobbin 2, this will increase the overall size of the transformer 1.

In the transformer 10 shown in FIG. 5, the primary winding 12 and the secondary winding 15 are wound concentrically on the first bobbin 11 and the second bobbin 14, respectively, achieving good coupling therebetween. Furthermore, because the secondary winding 15 is wound on the second bobbin 14 which itself is disposed radially outward of the first bobbin 11, a sufficient distance is provided between the secondary winding 15 and a core to facilitate insulation therebetween. However, use of the two bobbins 11 and 14 increases the cost of the transformer. In addition, because the two windings 12 and 15 must be separately wound on the two bobbins 11 and 14, the winding process takes a lot of time, raising manufacturing costs.

Furthermore, if a tertiary winding is required in either of the transformers 1 and 10, it will require a thickness which is different from that of the primary winding. Since these windings are wound adjacent to each other, the winding process involves a changing of wires which takes more time. This problem could be overcome by winding the tertiary winding (which is the same thickness as the secondary winding) adjacent the secondary winding. However, because this would require that the tertiary winding wire be thin, the ends of the tertiary winding may not be properly connected to the terminals due to the vibration of the bobbin with respect to the terminals.

### SUMMARY OF THE INVENTION

The present invention provides a transformer including:

a bobbin having a first and second tube-shaped members which are coaxial and integral with one another, said first tube-shaped member being located radially within said second tube-shaped member so as to form a gap located therebetween;

a first winding comprising an air-core coil located in said gap between said first and second tube-shaped members of said bobbin; and

a second winding affixed to said second tube-shaped member of said bobbin.

The air-coil is preferably not affixed to the first and second tube-shaped members. Rather, it is preferably inserted into the gap between the two tube-shaped members.

While the two coaxial members are preferably tubular in shape, other cross-sections can be used. For example, any polygonal cross-section, such as a triangular, rectangular, other polygonal cross-section or any oval or irregular cross-section, can be used.

Preferably, the first winding has a relatively small number of turns and serves as an input winding which allows a current in association with a low voltage to flow therethrough, and the second winding has a relatively large number of turns and serves as an output winding which allows a current in association with a high voltage to flow therethrough.

The transformer may further include a third winding wound on the second tube-shaped member.

The third winding preferably serves as a feedback winding which allows a small current to flow therethrough.

### BRIEF DESCRIPTION OF THE DRAWINGS

Other features and advantages of the present invention will become apparent from the following description of the invention which refers to the accompanying drawings.

FIG. 1 is an exploded perspective view of a transformer according to an embodiment of the present invention.

FIG. 2 is a sectional view of the transformer shown in FIG. 1.

FIG. 3 is an exploded perspective view of a transformer according to another embodiment of the present invention.

FIG. 4 is a perspective view of a conventional transformer.

FIG. 5 is an exploded perspective view of another conventional transformer.

### DESCRIPTION OF THE PREFERRED EMBODIMENTS

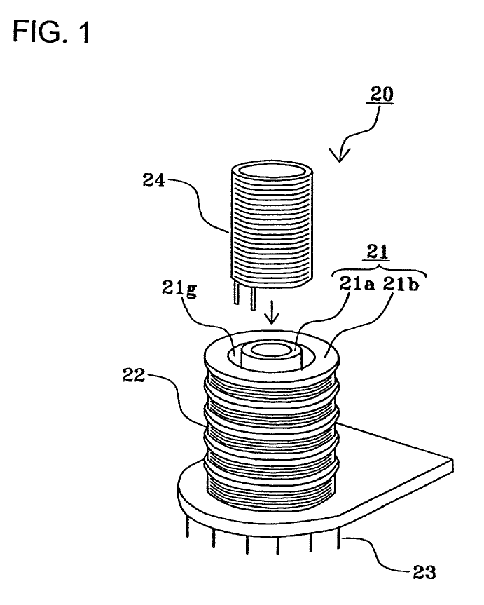

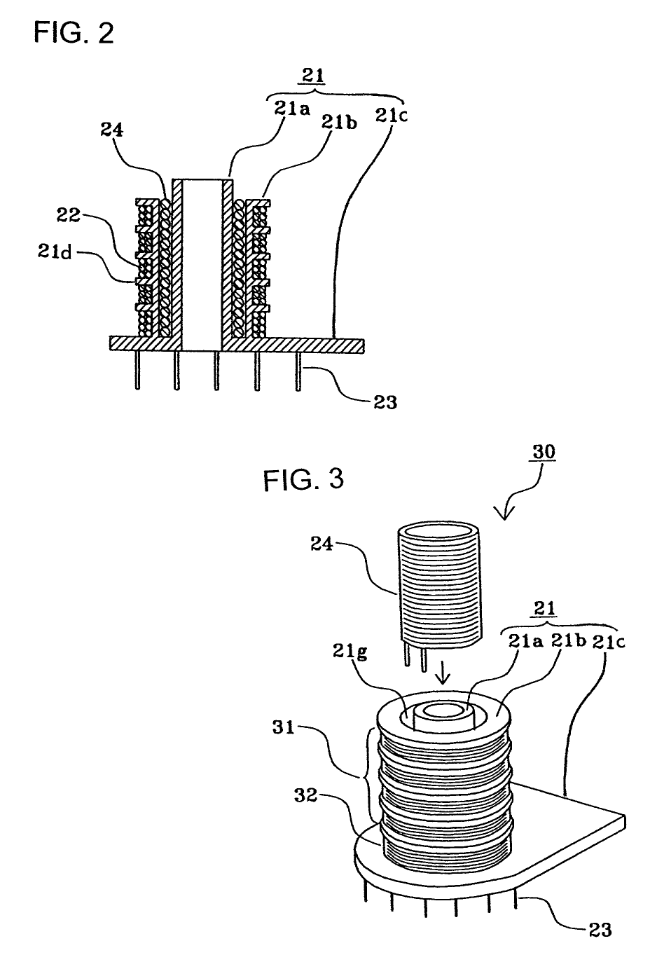

Referring to FIGS. 1 and 2, the transformer 20 includes a bobbin 21 having a first and second cylindrical members 21a and 21b which are formed integrally with each other so as to form concentric circles having a gap 21g therebetween. The lowermost ends of the cylindrical members 21a, 21b are coupled together by a radially extending base member 21c. A plurality of flanges 21d extend radially outward from the cylindrical member 21b. A secondary winding 22 is wound on the second cylindrical member 21b.

A primary winding 24, defined by an air-coil, is inserted into the gap 21g. As used herein, the term “air-coil” refers to a coil which is not supported by a bobbin or similar core. The air-coil is preferably formed by a relatively thick wire so as to allow a large current in association with a low voltage to flow therethrough. The ends of the secondary winding are connected to respective terminals 23 extending from the base of the bobbin 21 after the primary winding 24 is inserted into the gap 21g. A relatively thin wire is used for the secondary winding 22 so as to allow a small current in association with a high voltage to flow therethrough. The ends of the secondary winding 22 are not connected to any of the terminals 23.

The air-coil defining the primary winding 24 can be readily manufactured by winding a self-bonding wire on a cylindrical member which serves as a core, heating the wire so that the bonding layer of the wire is fused to achieve a mutual bonding, and then removing the cylindrical member to form an air-coil.

Since the primary winding 24 and the secondary winding 22 are concentric, they achieve a good coupling therebetween. In addition, because the secondary winding 22 is wound on the second cylindrical member 21b, a sufficient distance is provided between the secondary winding 22 and a core (not shown) extending through a central aperture of the first cylindrical member 21a to achieve a desirable insulation therebetween while at the same time keeping the size of the transformer small. Because only a single bobbin is used, the number of parts, and therefore the cost of components, are reduced. Furthermore, because the preferred embodiment avoids using wires of different thickness on a single bobbin, the time which is otherwise required to change wires during the winding process is avoided, thereby speeding up the manufacturing process.

As a result of the foregoing, the transformer 20 achieves an improved coupling, reduction in size, tolerance for high voltages, and reduction in cost compared to the prior art transformers described above.

FIG. 3 is an exploded perspective view of a transformer 30 according to another embodiment of the present invention. In FIG. 3, parts which are identical or equivalent to those in FIGS. 1 and 2, are indicated by the same reference characters and a further description thereof is omitted.

The primary difference between transformers 20 and 30 are that transformer 30 includes a tertiary winding 32 located on the secondary member 21b adjacent the secondary winding 31. In the preferred embodiment shown in FIG. 3, the tertiary winding 32 is located below the secondary winding 31, at axially removed from the secondary winding 31. A relatively thin wire is preferably used for the secondary winding 31 so as to allow a small current in association with a high voltage to flow therethrough. The ends of the secondary winding 31 are not connected to the terminals 23. Because only a small current in association with a low voltage flows through the tertiary winding 32, the tertiary winding 32 is implemented by a wire which is as thin as the secondary winding 31. The ends of the tertiary winding are preferably connected to respective terminals 23.

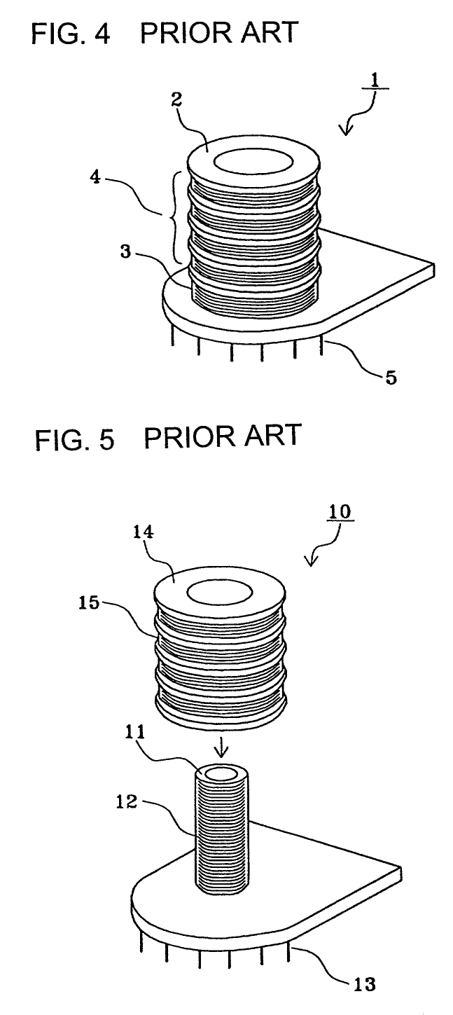

In contrast to the transformers 1 and 10 shown in FIGS. 4 and 5, respectively, the tertiary winding 32 of transformer 30 is wound adjacent to the secondary winding 31, not adjacent to the primary winding 24. Because the secondary winding 31 and the tertiary winding 32 can be implemented using the same thin wire, there is no need to change the wire during the winding process, saving time and reducing the cost of manufacturing. Furthermore, because the tertiary winding 32 is not wound adjacent the primary winding 24 and is instead wound directly on the bobbin 21 having the terminals 23, the possibility that the ends of the tertiary winding 32 are not properly connected to the terminals 23 due to the vibration of the bobbin 21 with respect to the terminals 23 is reduced, achieving improved stability.

Accordingly, the transformer 30 achieves a reduction in cost and improved stability compared to the above described prior art even though the tertiary winding 32 is incorporated therein.

Although the bobbin 21 has been described in the above embodiments as having a cylindrical structure with a circular cross section, the structure is not so limited and may have any suitable cross-section.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. A transformer comprising:
a bobbin having first and second tube-shaped members which are coaxial and integral with one another, said first tube-shaped member being located radially within said second tube-shaped member so as to form a gap located therebetween;
a first winding comprising an air-core coil located in said gap between said first and second tube-shaped members of said bobbin; and
a second winding affixed to said second tube-shaped member of said bobbin.

2. A transformer according to claim 1, wherein said air-coil is not affixed to either said first or second tube-shaped members.

3. A transformer according to claim 1, wherein said first winding has a smaller number of turns than said second winding and serves as an input winding which allows a first current associated with a first voltage to flow therethrough, said second winding serving as an output winding which allows a second current associated with a second voltage, higher than said first voltage, to flow therethrough.

4. A transformer according to one of claim 3, further comprising a third winding wound on said second tube-shaped member.

5. A transformer according to claim 4, wherein said third winding serves as a feedback winding which allows a current which is smaller than said second current to flow therethrough.

6. A transformer according to one of claim 1, further comprising a third winding, separate from said second winding, located on said second tube-shaped member.

7. A transformer according to claim 6, wherein said third winding serves as a feedback winding which allows a current which is smaller than said second current to flow therethrough.

8. A transformer according to claim 1, wherein said first and second tube-shaped members are coupled together by a radially extending base member.

9. A transformer according to claim 8, further including terminals extending from said radially extending base member.

10. A transformer according to claim 9, wherein at least two of said terminals are coupled to said secondary winding.

11. A transformer comprising:
a bobbin having first and second axially extending members which are coaxial and integral with one another, said first member being located radially within said second member so as to form a gap therebetween;
a first winding comprising an air-core coil located in said gap; and
a second winding affixed to said second member.

12. A transformer according to claim 11, wherein said air-coil is not affixed to either said first or said axially extending members.

13. A transformer according to claim 11, wherein said first winding has a smaller number of turns than said second winding and serves as an input winding which allows a first current associated with a first voltage to flow therethrough, said second winding serving as an output winding which allows a second current associated with a second voltage, higher than said first voltage, to flow therethrough.

14. A transformer according to one of claim 13, further comprising a third winding wound on said second axially extending member.

15. A transformer according to claim 14, wherein said third winding serves as a feedback winding which allows a current which is smaller than said second current to flow therethrough.

16. A transformer according to one of claim 1, further comprising a third winding, separate from said second winding, located on said second axially extending member.

17. A transformer according to claim 16, wherein said third winding serves as a feedback winding which allows a current which is smaller than said second current to flow therethrough.

18. A transformer according to claim 1, wherein said first and second axially extending members are coupled together by a radially extending base member.

19. A transformer according to claim 18, further including terminals extending from said radially extending base member.

20. A transformer according to claim 19, wherein at least two of said terminals are coupled to said secondary winding.
